(19) United States
(12) Patent Application Publication
(10) Pub. No.: US 2010/0328828 A1
(43) Pub. Date: Dec. 30, 2010

(54) SYSTEM AND METHOD FOR PROTECTING A CIRCUIT

(76) Inventor: Jian Xu, Windsor (CA)

Correspondence Address: Carlson, Gaskey & Olds/Masco Corporation, 400 West Maple Road, Suite 350, Birmingham, MI, 48009, US

(21) Appl. No.: 12/492,222

(22) Filed: Jun. 26, 2009

(51) Int. Cl. H02H 3/07

(52) U.S. Cl. 361/59

(57) ABSTRACT

A method of protecting a circuit includes measuring a value associated with a circuit having a current flowing through a switch to a load and comparing the measured value to a threshold. If the measured value meets or exceeds the threshold, the switch is turned OFF and a counter is incremented. If the counter is less than the counter limit, and a predefined time period has elapsed, the switch is turned back ON.

### BACKGROUND OF THE INVENTION

This application relates to circuit protection, and more particularly to a method of providing circuit protection while avoiding nuisance tripping.

Previous circuit protection methods, such as a standard fuse or circuit breaker, simply interrupt a current once it exceeds a threshold (e.g. a current threshold). Fuses, for example, have a slow response time, during which damage to a load may occur. Also, transient currents can exceed such thresholds for brief periods of time, causing nuisance current interruptions.

### SUMMARY OF THE INVENTION

A method of protecting a circuit includes measuring a value associated with a circuit having a current flowing through a switch to a load and comparing the measured value to a threshold. If the measured value meets or exceeds the threshold, the switch is turned OFF and a counter is incremented. If the counter is less than the counter limit, and a predefined time period has elapsed, the switch is turned back ON.

A protection circuit includes a power source, a load, a switch operable to control a flow of current from the power source to the load. A detection circuit is operable to measure a value associated with the protection circuit, and is operable to compare the measured value to a threshold. A switch controller is operable to turn the switch ON or OFF. If the measured value meets or exceeds the threshold, the switch controller turns the switch OFF and increments a counter. If the counter is less than a counter limit, and a predefined time period elapses, the switch controller turns the switch ON.

These and other features of the present invention can be best understood from the following specification and drawings, the following of which is a brief description.

### BRIEF DESCRIPTION OF THE DRAWINGS

FIG. 1 schematically illustrates a method of protecting a circuit.

FIG. 2 schematically illustrates a protection circuit implementing the method of FIG. 1.

### DETAILED DESCRIPTION OF THE PREFERRED EMBODIMENT

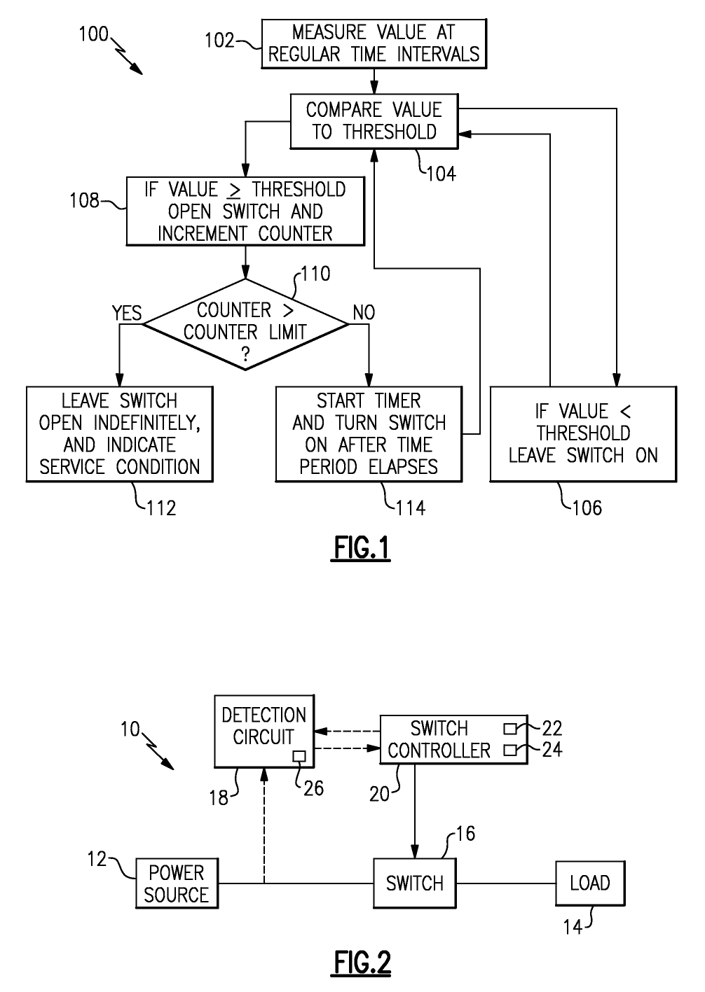

FIG. 1 schematically illustrates a method 100 of protecting a circuit. However, the method 100 can also be used to protect just a circuit component (e.g. a solid state switch). FIG. 2 schematically illustrates a protection circuit 10 implementing the method 100 of FIG. 1. The circuit 10 includes a power source 12, a load 14, a switch 16, a detection circuit 18 and a switch controller 20. The switch 16 is operable to control a flow of current from the power source 12 to the load 14. In one example the switch 16 corresponds to a solid state switching device (e.g. MOSFET, IGBT, etc.). The switch controller 20 includes a counter 22 and a timer 24, and the detection circuit 18 includes a processing unit 26. The load 14 could correspond to a lighting load, for example. Of course, other loads could be used.

Referring to FIG. 1, the detection circuit 18 measures a value associated with the circuit 10 (step 102) at a predefined time interval. In one example the value is only measured if the switch 16 is ON. In one example the time interval is very short such that the value is being measured continuously. The processing unit 26 compares the measured value to a threshold (step 104), and if the measured value is less than the threshold, the switch controller 20 leaves the switch 16 ON (step 106). If the measured value meets or exceeds the threshold, the switch controller 20 turns the switch 16 OFF and increments the counter 22 (step 108).

If the counter 22 exceeds a counter limit (step 110), the switch controller 20 leaves the switch 16 OFF and indicates a service condition (step 112). In one example, indicating a service condition includes notifying an individual that the power source 12 or the load 14 needs inspection.

If the counter 22 is less than the counter limit (step 110), the timer 24 is started. Once a predefined time period associated with the timer 24 has elapsed, the switch 16 is turned ON (step 114) and the timer 24 is reset. In one example the time period is on the order of 5-50 mini seconds. Once the switch 16 is turned back ON, steps 104-114 may then be selectively repeated while protection is desired.

In one example, the switch controller 20 turns the switch 16 OFF or ON to protect the switch 16, not to protect the load 14, detection circuit 18, or switch controller 20.

The value associated with the circuit 10 could correspond to a number of different conditions for which it is desirable to provide protection. In one example the measured value is an electrical current flowing through the switch 16 to the load 14, and the threshold is a current threshold. In one example the measured value is a temperature of the protection circuit 10, and the threshold is a temperature threshold. In one example the measured value is an amount of energy flowing from the power source 12 to the load 14, the threshold is an energy threshold, and the processing unit 26 is operable to calculate energy using equations #1, #2 below.

W=V*I equation #1

where W is wattage;
V is a voltage; and
I is an amount of current.

E=V*I*t equation #2

where E is an amount of energy; and
t is an amount of time.

The method 100 enables successful detection of damaging conditions (e.g. high current spikes, high temperatures, etc.) in the circuit 10 to effectively protect the circuit 10, while at the same time preventing nuisance tripping resulting from non-damaging conditions (e.g. high current spikes resulting from in-rush current, noise, electromagnetic interference, etc.). Nuisance tripping is avoided by the retrial approach (steps 108-114), since non-damaging conditions normally have a short time duration.

In one example, the opening of switch 16 (step 108) and subsequent closing of the switch 16 (step 114) happens quickly enough (e.g. on the order of 1-20 mini seconds) that if the load 14 is a lighting load the human eye would not detect the load 14 having been turned OFF. Thus, in this example the human eye would be unable to detect a single OFF/ON period for the switch 16, or multiple OFF/ON periods (i.e. step 104, 108, 110, 114 repeated several times consecutively).

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of protecting a circuit:
measuring a value associated with a circuit having a current flowing through a switch to a load;
comparing the measured value to a threshold;
turning the switch OFF and incrementing a counter in response to the measured value meeting or exceeding the threshold; and
turning the switch ON in response to a predefined time period elapsing and the counter being less than the counter limit.

2. The method of claim 1, wherein said step of measuring a value associated with a circuit having a current flowing through a switch to a load includes measuring a current flowing through the switch to the load.

3. The method of claim 1, wherein said step of measuring a value associated with a circuit having a current flowing through a switch to a load includes measuring an amount of energy flowing through the switch to the load.

4. The method of claim 1, wherein said step of measuring a value associated with a circuit having a current flowing through a switch to a load includes measuring a temperature of the circuit.

5. The method of claim 1, wherein the switch is a solid state device, and wherein said step of turning the switch OFF and incrementing a counter in response to the measured value meeting or exceeding the threshold is performed to protect the solid state device.

6. The method of claim 1, further comprising:
leaving the switch ON in response to the measured value being less than the threshold.

7. The method of claim 1, wherein the predefined time period begins after said step of turning the switch OFF and incrementing a counter in response to the measured value meeting or exceeding the threshold.

8. The method of claim 1, wherein said step of measuring a value associated with a circuit having a current flowing through a switch to a load is continuously performed at predefined time intervals when the switch is ON.

9. The method of claim 1, further comprising:
indicating a service condition in response to the counter exceeding a counter limit.

10. The method of claim 9, wherein said step of indicating a service condition in response to the counter exceeding a counter limit includes notifying an individual that at least one of a power source providing the flow of electrical current and the load needs inspection.

11. A protection circuit, comprising:
a power source;
a load;
a switch operable to control a flow of current from the power source to the load;
a detection circuit operable to measure a value associated with the protection circuit and to compare the measured value to a threshold; and
a switch controller operable to turn the switch ON or OFF, wherein the switch controller turns the switch OFF and increments a counter in response to the measured value meeting or exceeding the threshold, and turns the switch ON in response to a predefined time period elapsing and the counter being less than the counter limit.

12. The circuit of claim 11, wherein the value associated with the protection circuit is an amount of current flowing from the power source to the load, and wherein the threshold is a current threshold.

13. The circuit of claim 11, wherein the value associated with the protection circuit is an amount of energy flowing from the power source to the load, and wherein the threshold is an energy threshold.

14. The circuit of claim 11, wherein the value associated with the circuit is a temperature of the protection circuit, and wherein the threshold is a temperature threshold.

15. The circuit of claim 11, wherein the switch controller leaves the switch ON in response to the measured value being less than the threshold.

16. The circuit of claim 11, wherein the predefined time period begins the switch controller turns the switch OFF in response to the measured current meeting or exceeding the threshold.

17. The circuit of claim 11, wherein the detection circuit measures the electrical current flowing from the power source to the load at predefined time intervals when the switch is ON.

18. The circuit of claim 11, wherein the switch controller indicates a service condition in response to the counter exceeding a counter limit.

19. The circuit of claim 18, wherein switch controller indicates a service condition by notifying an individual that at least one of the power source and the load needs inspection.
